(19) United States
(12) Patent Application Publication
(10) Pub. No.: US 2005/0036907 A1
(43) Pub. Date: Feb. 17, 2005

(54) Inspection system

(75) Inventor: Kazumori Shoji, Tokyo (JP)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: JEOL Ltd., Akishima (JP)

(21) Appl. No.: 10/888,431

(22) Filed: Jul. 9, 2004

(30) Foreign Application Priority Data
Jul. 10, 2003 (JP) 2003-195014

(51) Int. Cl. G01N 35/00

(52) U.S. Cl. 422/58

(57) ABSTRACT

An inspection system capable of making effective use of RFID (Radio Frequency IDentification) technology. The inspection system has first and second transport mechanisms. The first mechanism transports a sample holder holding a storage medium permitting writing, reading, and erasure of information from an analysis portion. The second mechanism receives the sample holder transported in by the first mechanism, injects an aliquot of a new sample into the holder, and then transports the holder to the analysis portion. Each of the transport mechanisms has writing means for writing at least one of (1) the identification number of the sample to be metered and injected as an aliquot, (2) information about metering and injection of sample, and (3) analytical information into the storage medium, as well as reading means for reading at least one of the three kinds of information (1)-(3) from the storage medium when the aliquot is analyzed.

### BACKGROUND OF THE INVENTION

1. Field of the Invention

The present invention relates to an inspection system for inspecting samples, such as blood, blood serum, urine, or the like.

2. Description of Related Art

Where samples such as collected blood, blood serum, urine, or the like are processed by the prior art sample processor (e.g., where a sample is divided into aliquots and injected by a sample dispenser or where an analysis is made by an analyzer instrument), the samples are received in medium size containers, e.g., test tubes or blood collection tubes, or microplates, and then set in a rack. Under this condition, the sample aliquots (fractions) are managed.

Where test tubes are used, a barcode label is stuck at a given position on each test tube. A test tube identification number is written as a barcode on the label for each test tube.

A barcode reader is disposed opposite to the rack to read the test tube identification number via the barcode.

A CPU is connected with the barcode reader. An external computer system, a keyboard for control, a display unit, and so on are connected with the CPU. Managerial information, such as information about metering and injection of a sample or analytical information about each test tube, is previously written in a storage medium, such as a floppy disk disposed in the computer system, corresponding to the test tube identification number.

Accordingly, the operator utilizes the computer system by manipulating the keyboard. The information about metering and injection of sample or analytical information is read from the storage medium according to the test tube identification number. The sample is divided into aliquots and injected by a sample dispenser according to the information about metering and injection of sample by the sample dispenser or analyzed according to the analytical information by the analyzer instrument.

The aforementioned information about the metering and injection of sample (e.g., information about samples for identifying patients and samples including patent identification numbers and sample identification numbers) is recorded in the storage medium. In addition, information about the sample metering-and-injection method, such as the amounts of aliquots and the positions of test tubes in which the aliquots are put, is recorded. The analytical information includes information about the samples. Additionally, information about the analytical method, such as items to be analyzed, kinds of reagents, and amounts of reagents, is recorded as analytical information.

If a rack is set in the sample dispenser in a medical organization, the rack is transported by a conveyor device. During this period, the test tube identification numbers are read via the barcodes by the barcode reader. The identification numbers are sent to the computer system.

The computer system reads the sample metering and injection information corresponding to the test tube identification numbers from the storage medium and sends the information to the sample dispenser.

Accordingly, the sample dispenser draws in a preset aliquot amount of sample from each test tube according to the information about metering and injection of sample and injects the aliquots of sample into destination test tubes set in a separate rack. In this way, the sample is metered and injected.

Barcode labels in which test tube identification numbers have been written as barcodes can be placed on the destination test tubes. In this case, the test tube identification numbers are read via the barcodes by a separate barcode reader and sent to the computer system. The sample metering and injection information about the sample aliquots in the destination test tubes is written into a storage medium corresponding to the test tube identification numbers by the computer system.

In an inspection organization, if a rack is set in the analyzer instrument, the rack is transported by a transport device. During this interval, the test tube identification numbers are read via the barcodes by a barcode reader and sent to the computer system.

The computer system reads the analytical information corresponding to the test tube identification numbers from the storage medium and sends the information to the analyzer instrument. Therefore, the instrument injects given reagents into test tubes according to the analytical information and makes analyses regarding given items of analysis.

With the prior art sample processor, however, it is necessary to connect the external computer system, keyboard for control, display unit, and so on with the CPU of the barcode reader. Consequently, there is the problem that the cost of the sample processor is increased.

A sample processor that solves this problem has been proposed in Japanese Patent Laid-Open No. 2002-40033. This proposed processor stores test tube identification numbers, information about metering and injection of sample, and analytical information by RFID (Radio Frequency IDentification) technology without using barcodes, in order to reduce the cost.

Each barcode identification number is a printed fixed sequential number that has been previously assigned. If this identification number is used for a sample aliquot, collation with the identification number of the undivided original sample is indispensable. Furthermore, in the past, analytical information has been obtained based on such sample aliquot identification numbers and so it has been necessary to build a complex communication system between the CPUs for collation of IDs.

If a RFID technique is used instead of barcode technology, analytical information (such as the identification number of the original sample, information indicating analytical conditions, amounts of injected aliquots, dilution rate, and the modular block used for analysis, information indicating the completion of analysis of each analytical module, and information indicating the time at which metering and injection of the sample are done) can be stored directly onto the sample aliquot. Therefore, ID management and complex transfer of information between CPUs can be omitted. This creates the advantage that the reliability is enhanced.

With an inspection system using barcodes, if the CPU is reset due to trouble or repair, the information within the memory is erased. In consequence, managerial information corresponding to IDs is lost. However, in the case of RFID, the identification number of the original sample and other analytical information are left in the memory chip. The analysis can be continued without discarding the sample.

Limitations are imposed on the dimensions of barcode labels. The labels cannot be stuck in too narrow spaces. In the case of RFID, a chip can be molded to the bottom of a sample aliquot holder measuring only 15 mm square.

In barcode technology, the barcode reader has some size in spite of the fact that the positional relation between the barcode label and the reader is important. Therefore, limitations are placed on the installation position to avoid interference with the sample dispenser. On the other hand, in RFID technology, an RFID antenna can be installed just under the injection position. Since the controller substrate can be disposed inside the enclosure, little space is taken up.

Limitations are imposed on the orientation of reading because each barcode is on the surface of a sample aliquot holder. Furthermore, contrivance has been necessary to achieve waterproofness. In RFID technology, a chip is molded to the bottom of a sample aliquot holder and so no limitations are placed on the orientation of reading. Also, no contrivance is necessary for waterproof work.

### SUMMARY OF THE INVENTION

It is an object of the present invention to provide an inspection system capable of making effective use of the excellent features of RFID technology.

This object is achieved by an inspection system comprising: a first transport mechanism for forwarding a sample holder fitted with a storage medium permitting writing, reading, and erasure of information from an analysis portion; and a second transport mechanism for receiving the sample holder forwarded from the first transport mechanism and transporting the holder to the analysis portion after a new sample is metered and injected as an aliquot into the holder. Each of the transport mechanisms has writing means for writing at least one of (1) the identification number of the sample metered and injected as an aliquot, (2) information about metering and injection of sample, and (3) analytical information into the storage medium when the sample is metered and injected as an aliquot. Furthermore, each transport mechanism has reading means for reading at least one of these three kinds of information (1)-(3) from the storage medium when the sample aliquot is analyzed.

In one embodiment of the present invention, the storage medium is an RFID chip. Preferably, the writing means is an RFID antenna and the reading means is an RFID antenna. In yet another embodiment of the present invention, there is further provided erasing means for erasing the information in the storage medium fitted in the sample holder prior to metering and injection of the sample. Preferably, the erasing means is an RFID antenna.

In an additional embodiment of the present invention, there is further provided a third transport mechanism for receiving the sample holder transported in by the second transport mechanism and for transporting it very close to the analysis portion.

In a still further embodiment of the present invention, the third transport mechanism is fitted with second reading means for reading at least one of the three kinds of information described above from the storage medium. Preferably, the second reading means is an RFID antenna.

In another embodiment of the present invention, there is further provided a fourth transport mechanism for transporting the sample holder for reinspection and the fourth transport mechanism is fitted with third reading means for reading at least one of the three kinds of information described above from the storage medium. Preferably, the third reading means is an RFID antenna.

Other objects and features of the present invention will appear in the course of the description thereof, which follows.

### BRIEF DESCRIPTION OF THE DRAWINGS

FIG. 1 is a schematic block diagram of an inspection system according to the present invention;

FIG. 2 is a schematic representation of another inspection system according to the present invention;

FIG. 3 is a schematic representation of a ftrther inspection system according to the present invention; and

FIG. 4 is a schematic representation of yet another inspection system according to the present invention.

### DESCRIPTION OF THE PREFERRED EMBODIMENTS

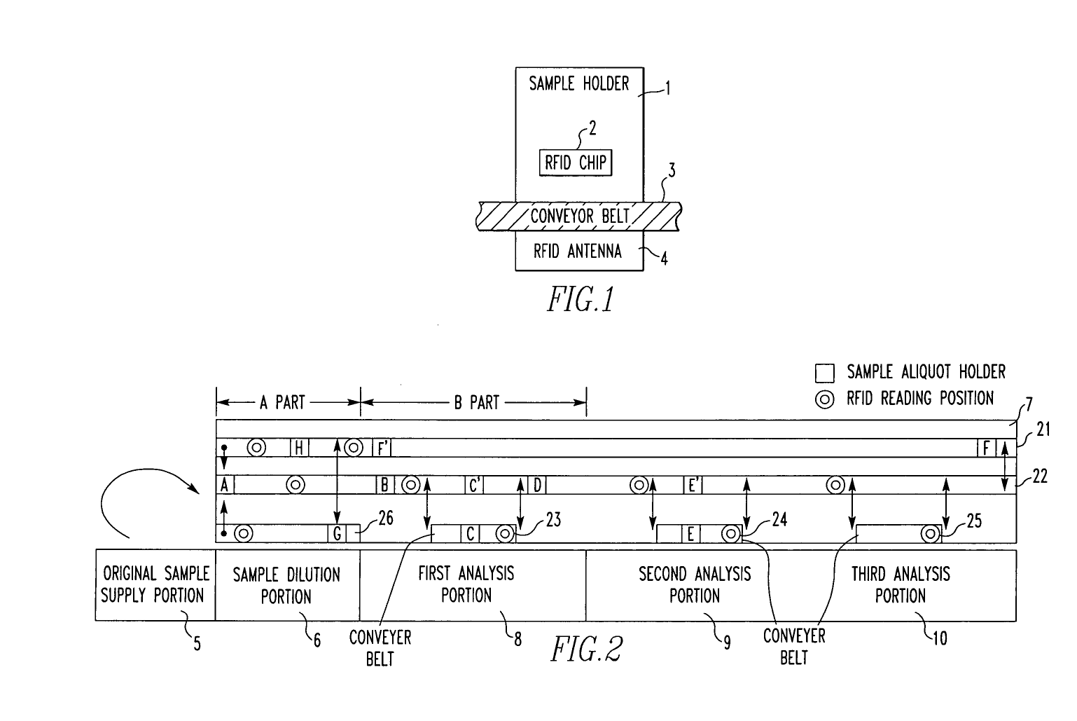

The preferred embodiments of the present invention are hereinafter described with reference to the drawings. Referring to FIG. 1, there is shown an inspection system according to the present invention. The inspection system has a sample container or a sample container holder for accommodating the container. The sample container and container holder may be hereinafter collectively referred to as the sample holder 1. An RFID chip 2 is molded to the bottom of the sample holder 1. The holder 1 is carried on a conveyor belt 3. An RFID antenna 4 is installed just under the belt 3 such that the RFID chip 2 and antenna 4 are located on the opposite sides of the belt 3.

Information is written into the RFID chip 2, information is read from the chip 2, or information in the chip 2 is erased, using the RFID antenna 4.

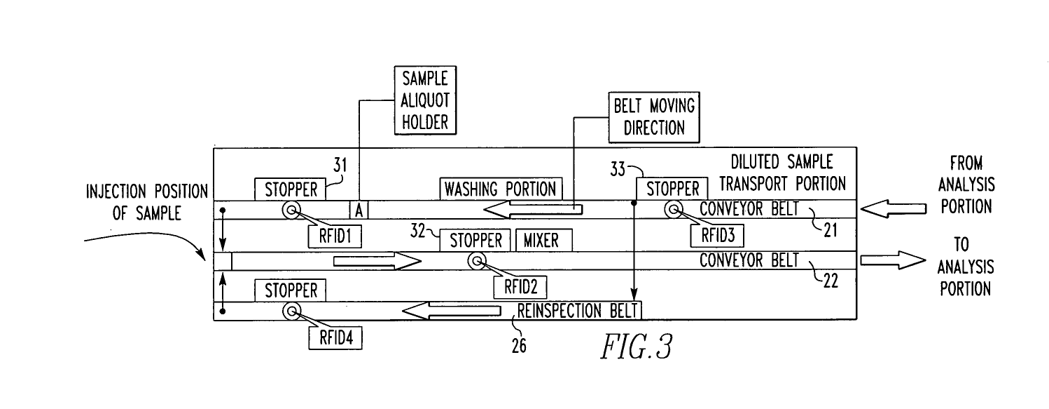

One form of inspection system fitted with the RFID components described above is shown in FIG. 2. In the present embodiment, the inspection system consists of an original sample supply portion 5, sample dilution portion 6, a diluted sample transport portion 7, and three analysis portions 8, 9, 10. A sample aliquot holder is moved from right to left on the conveyor belt 21 of the diluted sample transport portion 7 and from left to right on conveyor belts 22, 23, 24, 25. In the figure, the arrows indicate mechanisms for transferring the aliquot holder between the conveyor belts.

The inspection system operates as follows. First, a sample supplied from the original sample supply portion 5 is drawn in by the pipette of the sample dilution portion 6 and diluted. A part of the sample is metered and injected into a sample aliquot holder located at point A (injection position) on the conveyor belt 22 of the diluted sample transport portion 7. The identification number of the source sample and analytical information are written into the RFID chip 2 embedded in the sample aliquot holder 1 on the conveyor belt 22.

Then, the aliquot holder 1 is transported to point C′ through point B opposite to the first analysis portion 8 by the conveyor belt 22. Where an instruction for analysis is given from the first analysis portion 8, the aliquot holder 1 is moved into point C on the conveyor belt 23 from point C′ on the conveyor belt 22. In the first analysis portion 8, the sample is metered, injected as an aliquot, and analyzed. Then, the aliquot holder 1 is returned to point D on the conveyor belt 22 from the conveyor belt 23. The aliquot holder 1 is conveyed to point E′ on the second analysis portion 9 from point D on the conveyor belt 22.

Where an instruction for analysis is not given from the first analysis portion 8, the aliquot holder 1 is conveyed intact to point E′ opposite to the second analysis portion 9 through point D from point C′ on the conveyor belt 22.

Where an instruction for analysis is given from the second analysis portion 9, the aliquot holder 1 is shifted from point E′ on the conveyor belt 22 to point E on the conveyor belt 24. In the second analysis portion 9, the sample is metered, injected as an aliquot, and analyzed. Then, the aliquot holder 1 is returned to the conveyor belt 22 from the conveyor belt 24 and transported to the third analysis portion 10.

On the other hand, where an instruction for analysis is not given from the second analysis portion 9, the aliquot holder 1 is conveyed intact to the position opposite to the third analysis portion 10 from point E′ on the conveyor belt 22.

In the third analysis portion 10, similar operations are performed. In the present embodiment, there are provided only three analysis portions. Where more analysis portions are provided, each analysis portion performs similar operations.

The aliquot holder 1 having undergone the analysis in the final analysis portion is moved to point F on the conveyor belt 21 from the conveyor belt 22. Then, the holder is transported to point F′ located immediately ahead of the sample dilution portion 6.

If the aliquot holder 1 is judged to be required to be inspected again according to the results of the analyses, the holder 1 is moved onto point G on a reinspection belt 26 from point F′ on the conveyor belt 22. Then, the holder 1 is returned to point A on the conveyor belt 22. A second analytical sequence exactly identical to the first analytical sequence is carried out.

The aliquot holder 1 judged not to be required to be reinspected at point F′ is conveyed from point F′ to point H on the conveyor belt 21 and then cleaned. Thereafter, the identification number of the source sample and analytical information written in the RFID chip 2 of the aliquot holder 1 are erased. The holder 1 is moved into point A on the conveyor belt 22. Then, the holder 1 is used for new metering and injection of sample.

Each aliquot holder 1 returned after undergoing reinspection is conveyed from point F′ to point H on the conveyor belt 21 and then cleaned in exactly the same way as the aliquot holder 1 not having undergone reinspection. After the cleaning, the identification number of the source sample and analytical information written in the RFID chip 2 of the aliquot holder 1 are erased. The holder 1 is moved into point A on the conveyor belt 22. Then, the holder is used for new metering and injection of sample.

FIG. 3 is an enlarged view of portion A of FIG. 2. A method of using RFID technology is illustrated with reference to FIG. 3. RFID3 is an RFID antenna for erasing the previous information stored in the RFID chip 2 of the aliquot holder 1 prior to new metering and injection of sample into the aliquot holder 1. The aliquot holder 1 is brought to a stop in the position of the RFID3 by a stopper 33. The previous information stored in the RFID chip 2 is erased.

Then, the stopper 33 is disengaged. The aliquot holder 1 is conveyed to the left on the conveyor belt 21. The holder 1 is brought to a stop in the position of RFID 1 by the stopper 31. Analytical information intrinsic to the source sample to be metered and injected (e.g., the identification number of the source sample, the amount of each aliquot, the dilution rate, and the injection time) is written into the RFID chip 2 of the aliquot holder 1.

After the end of the writing of the analytical information, the aliquot holder 1 is released from the stopper 31 and transported to the left end of the conveyor belt 21. Then, the holder is moved onto the conveyor belt 22. The source sample is metered and injected at point A.

It is also possible that the RFID1 acts as the role of the RFID3. Erasure of the previous information about the sample and writing of information about a new sample may both be done using only the RFID1 instead of the RFID3. Furthermore, both of the RFID3 and RFID1 or alternatively only the RFID1 may be located close to point A on the conveyor belt 22.

After metering and injection of the source sample, the aliquot holder 1 is conveyed to the right on the conveyor belt 22 and then brought to a stop at the position of the RFID2 by a stopper 32. At this position, the information about the identification number of the sample is read using the RFID2. A decision is made as to whether a stirring operation was performed by a mixer. Then, stirring in the aliquot holder 1 may or may not be done according to the result of the decision. Then, the holder 1 is transported to an analysis portion (not shown).

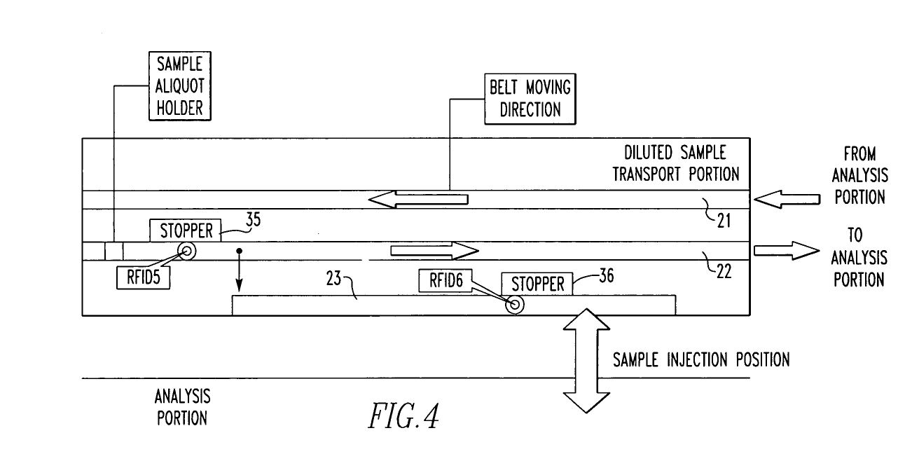

FIG. 4 is an enlarged view of portion B of FIG. 2. Continuation of the description of the method of using RFID technology is described with reference to FIG. 4. RFID5 is an RFID antenna for reading analytical information intrinsic to the source sample (e.g., the identification number of the source sample, the amount of each aliquot, the dilution rate, and the injection time) from the RFID chip 2 of the aliquot holder 1 sent from portion A of FIG. 1. The aliquot holder 1 is brought to a stop in the position of the RFID5 by a stopper 35. Then, information about the sample and analytical information are read by the RFID5. A decision is made as to whether the sample in the aliquot holder 1 should be analyzed or not by this analysis portion according to the analytical information read by the RFID5.

If the result of this decision is that no analysis is made in this analysis portion, the aliquot holder 1 is transported intact to the next analysis portion.

On the other hand, if the result of the decision is that an analysis is made in this analysis portion, the aliquot holder 1 is shifted onto the conveyor belt 23 from the conveyor belt 22. The holder 1 is conveyed to the immediate vicinity of the analysis portion by the conveyor belt 23. Then, the holder 1 is brought to a stop at the position of the RFID6 by a stopper 36. The identification number of the sample is read by the RFID6, and information about the identification number is transmitted to the analysis portion by a communication means (not shown).

The analysis portion receives various analytical parameters from the host CPU of the inspection system according to the identification number of the sample and prepares for sampling. Then, the aliquot holder 1 is transported to a sample injection position by the conveyor belt 23 and metered and injected into the analysis portion by a pipette (not shown). After the end of analysis, the aliquot holder 1 is returned onto the conveyor belt 22.

Then, the aliquot holder 1 is transported to the next analysis portion by the conveyor belt 22. Similar operations are performed.

The aliquot holder 1 having undergone the analysis in the analysis portion is transferred from the conveyor belt 22 to the conveyor belt 21 by a belt-to-belt shift mechanism (not shown). The continuation of the description of the method of using RFID technology is described by referring back to FIG. 3.

The aliquot holder 1 having undergone the analytical sequence in the analysis portion (not shown) is again transported to the left by the conveyor belt 21 and brought to a stop by the stopper 33. The holder 1 is made to wait for a reaction period of about 10 minutes. Then, data obtained by the analysis is calibrated. If reinspection is necessary, the aliquot holder 1 is moved onto the reinspection belt 26.

The aliquot holder 1 transported to the left by the reinspection belt 26 is brought to a stop by a stopper 34. The identification number of the sample is checked with the RFID4. Then, the holder 1 is again moved onto the conveyor belt 22 and sent to an analysis portion (not shown), where a reinspection is performed.

On the other hand, if reinspection is not necessary, the information stored in the RFID chip 2 of the aliquot holder 1 is erased before new injection into the aliquot holder 1 is carried out. Then, the stopper 33 is disengaged. The holder is transported to a cleaning mechanism by the conveyor belt 21 and cleaned. The aliquot holder 1 is reused for analysis of the next sample. Subsequently, the same operations are carried out repetitively and cyclically to analyze samples in turn.

An inspection system according to the present invention comprises: a first transport mechanism for forwarding a sample holder fitted with a storage medium permitting writing, reading, and erasure of information from an analysis portion; and a second transport mechanism for receiving the sample holder forwarded from the first transport mechanism and transporting the holder to the analysis portion after a new sample is metered and injected into the holder. Each of the transport mechanisms has writing means for writing at least one of (1) the identification number of the sample metered and injected, (2) information about metering and injection of sample, and (3) analytical information when the sample is metered and injected as an aliquot. Furthermore, each transport mechanism has reading means for reading at least one of the three kinds of information (1)-(3) from the storage medium when the sample aliquot is analyzed. Consequently, the inspection system can make effective use of the excellent features of RFID technology.

Having thus described my invention with the detail and particularity required by the Patent Laws, what is desired protected by Letters Patent is set forth in the following claims.

1. An inspection system having a first transport mechanism for forwarding a sample holder fitted with a storage medium permitting writing, reading, and erasure of information from an analysis portion and a second transport mechanism for receiving the sample holder forwarded from the first transport mechanism and transporting the holder to the analysis portion after a new sample is metered and injected as an aliquot into the holder, wherein each of said transport mechanisms comprises:
writing means for writing at least one of three kinds of information comprising (1) an identification number given to the sample to be metered and injected, (2) information about metering and injection of sample, and (3) analytical information when the sample is metered and injected as an aliquot; and
reading means for reading at least one of the three kinds of information (1)-(3) from the storage medium when the sample aliquot is analyzed.

2. The inspection system of claim 1, wherein said storage medium is an RFID chip.

3. The inspection system of claim 1, wherein said writing means is an RFID antenna.

4. The inspection system of claim 1, wherein said reading means is an RFID antenna.

5. The inspection system of claim 1, further comprising erasing means for erasing information in the storage medium fitted in the sample holder prior to metering and injection of the sample.

6. The inspection system of claim 1, wherein said erasing means is an RFID antenna.

7. The inspection system of claim 1, further comprising a third transport mechanism for receiving the sample holder and transporting it very close to the analysis portion after the holder is transported in by the second transport mechanism.

8. The inspection system of claim 7, wherein said third transport mechanism is fitted with second reading means for reading at least one of the three kinds of information from the storage medium.

9. The inspection system of claim 8, wherein said second reading means is an RFID antenna.

10. The inspection system of claim 1 or 7, further comprising a fourth transport mechanism for transporting the sample holder for reinspection.

11. The inspection system of claim 10, wherein said fourth transport mechanism is fitted with third reading means for reading at least one of the three kinds of information from the storage medium.

12. The inspection system of claim 11, wherein said third reading means is an RFID antenna.
